(19) United States
(12) Patent Application Publication
(10) Pub. No.: US 2020/0198704 A1
(43) Pub. Date: Jun. 25, 2020

(54) PROTECTIVE SYSTEM FOR A HIGH VOLTAGE MODULE ARRANGED IN A CRUSH ZONE OF AN ELECTRIFIED VEHICLE

(71) Applicants: Justin Smith, Royal Oak, MI (US); Neil Thomas, Clarkston, MI (US); Christopher R. Reynolds, Oxford, MI (US); Mark R. Fistler, Armada, MI (US); Robert J. Soroka, Metamora, MI (US); William E. Hughes, Oxford, MI (US)

(72) Inventors: Justin Smith, Royal Oak, MI (US); Neil Thomas, Clarkston, MI (US); Christopher R. Reynolds, Oxford, MI (US); Mark R. Fistler, Armada, MI (US); Robert J. Soroka, Metamora, MI (US); William E. Hughes, Oxford, MI (US)

(21) Appl. No.: 16/225,763

(22) Filed: Dec. 19, 2018

(51) Int. Cl. B62D 21/15; B60R 19/34

(52) U.S. Cl. CPC B62D 21/152; B60R 2019/007; B60R 19/34

(57) ABSTRACT

A protective system for a high voltage module of an electrified vehicle arranged at least partially in a crush zone of the vehicle comprises a housing defining a front end and a rear end and having the high voltage module disposed therein, wherein the front end is securely connected to a frame of the vehicle and the rear end is disconnected from or loosely connected to the frame, the front end including high voltage wiring for the high voltage module, and a displacement device connected to the frame behind the rear end of the housing, wherein in response to a vehicle impact event that compresses the frame in the crush zone, the displacement is configured to vertically displace the rear end of the housing and the high voltage module therein, thereby protecting the high voltage module and the high voltage wiring from damage during compression of the crush zone.

### FIELD

The present application generally relates to high voltage modules for electrified vehicles and, more particularly, to a protective system for a high voltage module of an electrified vehicle that is arranged in one of its crush zones.

### BACKGROUND

Electrified vehicles, such as plug-in hybrid electric vehicles (PHEVs), typically have a high voltage module. One example of this high voltage module is a power inverter module (PIM) that generates a high voltage direct current (DC). This high voltage DC could be used, for example, to power a high voltage component, such as a belt-driven starter generator (BSG) unit or an electric traction motor. These high voltage modules are typically very large and also require protection during vehicle impact events. One conventional arrangement for these high voltage modules is beneath the vehicle and centrally located outside of any crush zones. Because this arrangement is exposed to exterior conditions, the high voltage module may require additional protective and/or insulating components. Additionally, this arrangement may be susceptible to damage during extreme off-road driving scenarios. Accordingly, while such high voltage module systems work well for their intended purpose, there remains a need for improvement in the relevant art.

### SUMMARY

According to one example aspect of the invention, a protective system for a high voltage module of an electrified vehicle arranged at least partially in a crush zone of the vehicle is presented. In one exemplary implementation, the protective system comprises a housing defining a front end and a rear end and having the high voltage module disposed therein, wherein the front end is securely connected to a frame of the vehicle and the rear end is disconnected from or loosely connected to the frame, the front end also including high voltage wiring for the high voltage module, and a displacement device connected to the frame behind the rear end of the housing, wherein in response to a vehicle impact event that compresses the frame in the crush zone, the displacement is configured to vertically displace the rear end of the housing and the high voltage module therein, thereby protecting the high voltage module and the high voltage wiring from damage during compression of the crush zone housing the high voltage module.

In some implementations, the crush zone is beneath or behind rear seats of the vehicle and proximate to a rear wheel well portion and a floor portion of the frame of the vehicle. In some implementations, the vehicle impact event is a rear end impact. In some implementations, the rear end of the housing is loosely connected to the frame such that it is laterally constrained and, in response to the rear end impact, the rear end of the housing breaks free from the frame, and the displacement device is a wedge device that movably contacts the rear end of the housing to vertically displace the rear end of the housing and the high voltage module therein to move the high voltage module out of the crush zone. In some implementations, in the crush zone, the frame is compressed forward to where the rear end of the housing is loosely connected to the frame, thereby laterally pushing the wedge device in the same direction, which breaks the loose connection and lifts the rear end of the housing and the high voltage module therein upward and out of the crush zone so the high voltage module is not crushed by the compressed frame. In some implementations, the high voltage module is an integrated dual charging module (IDCM) comprising both a power inverter module (PIM) and a charging control module.

According to another example aspect of the invention, an electrified vehicle is presented. In one exemplary implementation, the electrified vehicle comprises a frame defining a crush zone where, in response to a vehicle impact event, at least a portion of the frame compresses, a high voltage module arranged at least partially in the crush zone of the vehicle, the high voltage module being configured to output a high voltage and having high voltage wiring connected thereto, and a protective system for the high voltage module, the protective system comprising a housing defining a front end and a rear end and having the high voltage module disposed therein, the front end being securely connected to the frame and the rear end being disconnected from or loosely connected to the frame, the front end including the high voltage wiring, and a displacement device connected to the frame behind the rear end of the housing, wherein in response to the vehicle impact event, the displacement device movably contacts the rear end of the housing to vertically displace the rear end of the housing and the high voltage module therein, thereby protecting the high voltage module and the high voltage wiring from damage during compression of the crush zone housing the high voltage module.

In some implementations, the crush zone is beneath or behind rear seats of the vehicle and proximate to a rear wheel well portion and a floor portion of the frame of the vehicle. In some implementations, the vehicle impact event is a rear end impact. In some implementations, the rear end of the housing is loosely connected to the frame such that it is laterally constrained and, in response to the rear end impact, the rear end of the housing breaks free from the frame, and the displacement device is a wedge device that movably contacts the rear end of the housing to vertically displace the rear end of the housing and the high voltage module therein to move the high voltage module out of the crush zone. In some implementations, in the crush zone, the frame is compressed forward to where the rear end of the housing is loosely connected to the frame, thereby laterally pushing the wedge device in the same direction, which breaks the loose connection and lifts the rear end of the housing and the high voltage module therein upward and out of the crush zone so the high voltage module is not crushed by the compressed frame. In some implementations, the high voltage module is an IDCM comprising both a PIM and a charging control module.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a functional block diagram of an example electrified vehicle having a high voltage module according to the principles of the present disclosure;

FIG. 2 is a side view diagram of an example protective system for the high voltage module and its high voltage and coolant lines arranged in a rear impact crush zone of the vehicle according to the principles of the present disclosure; and

FIGS. 3A-3B are side view diagrams of the protective system at a before and during or after an example rear impact event according to the principles of the present disclosure.

### DETAILED DESCRIPTION

As previously discussed, there exists an opportunity for improvements in the arrangement or packaging of a high voltage module of an electrified vehicle, such as a plug-in hybrid electric vehicle (PHEV). More particularly, it would be desirable to arrange the high voltage module in previously unused or unoccupied space. One example of such a space is beneath or behind a second or rear row of seats and proximate to a rear wheel well portion and a floor portion of the vehicle frame. This space, however, is located in or overlapping the edge of a rear impact crush zone of the vehicle. The term “crush zone” as used herein refers to an area on a particular vehicle that is likely to be damaged (e.g., by compression of the vehicle's frame) during a particular type of impact (front impact, side impact, rear impact, etc.). These high voltage modules are very expensive and also have high voltage lines/wires that need to be protected and isolated for safety reasons. Thus, there exists a need for a protective system that allows an electrified vehicle high voltage module to be arranged in one of the vehicle's crush zones.

Accordingly, a protective system for a high voltage module of an electrified vehicle is presented. In one exemplary implementation, the high voltage module is an integrated dual charger module (IDCM) that comprises both a power inverter module (PIM) in addition to a charging control module, but it will be appreciated that the protective system of the present disclosure could be applicable to any suitable high voltage module for an electrified vehicle. The high voltage module is arranged in a crush zone of the vehicle. In one exemplary implementation, the high voltage module is arranged in the rear impact crush zone beneath or behind the rear seats and proximate to a rear wheel well portion and a floor portion of the vehicle frame, but it will be appreciated that the high voltage module could be arranged in other crush zones of the vehicle (side impact crush zone, front impact crush zone, etc.).

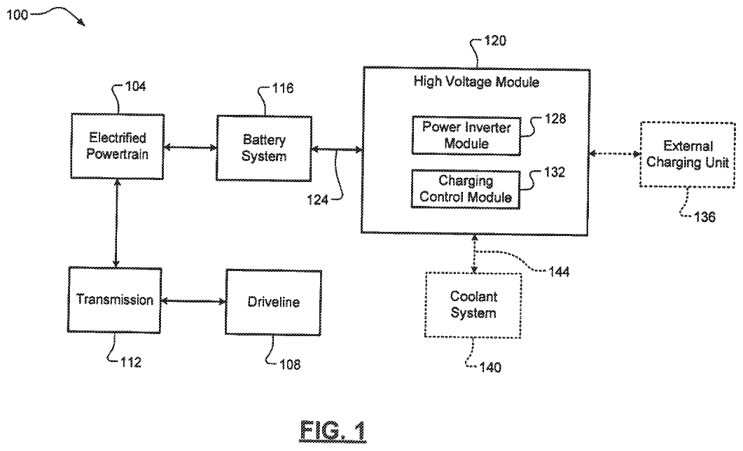

Referring now to FIG. 1, a functional block diagram of an example electrified vehicle 100 is illustrated. The vehicle 100 comprises an electrified powertrain 104 that generates drive torque that is transferred to a driveline 108 via a transmission 112 to propel the vehicle 100. The electrified powertrain 104 comprises, for example, an electric motor, an engine, or combinations thereof. A battery system 116 provides electrical energy to the electrified powertrain 104. A high voltage module 120 is associated with high voltage lines 124 connected to one or both of the electrified powertrain 104 and the battery system 116. In one exemplary implementation as shown, the high voltage module 120 is an IDCM having both a PIM 128 and a charging control module 132. In some implementations, the high voltage module 120 receives power from an optional external charging unit 136. The high voltage module 120 optionally has a coolant system 136 associated therewith, which provides cooling functionality (e.g., refrigeration) via coolant lines 140. A controller (not shown) controls other operation of the vehicle 100, such as controlling the electrified powertrain 104 to generate a desired drive torque. It will be appreciated that the vehicle 100 could include other components that are not shown, such as a low voltage (e.g., 12 volt) electrical system and a driver interface.

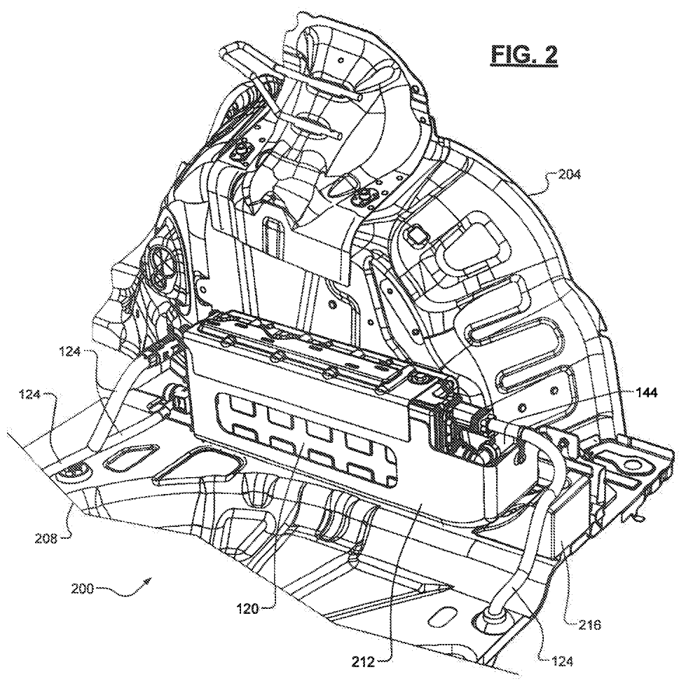

Referring now to FIG. 2, a side view diagram of an example protective system 200 for the high voltage module 120 is illustrated. In one exemplary implementation, the high voltage module 120 is arranged in a rear impact crush zone behind or beneath rear seats of the vehicle 100 and proximate to a wheel well portion 204 and a floor portion 208 of a frame of the vehicle 100. A portion of this area of the vehicle 100, for example, could conventionally be utilized to store a spare wheel/tire of the vehicle 100. As this area is not exposed to the exterior of the vehicle 100, however, additional protective and insulating systems are not required. The protective system 200 comprises a housing 212 that houses the high voltage module 120 and a displacement device 216 (e.g., a wedge device) configured to vertically displace at least a portion of the housing 212 to protect the high voltage module 120 and its high voltage and coolant lines 124, 144 in response to a rear impact event. An example rear impact event and the behavior of the protective system 200 will now be discussed in greater detail.

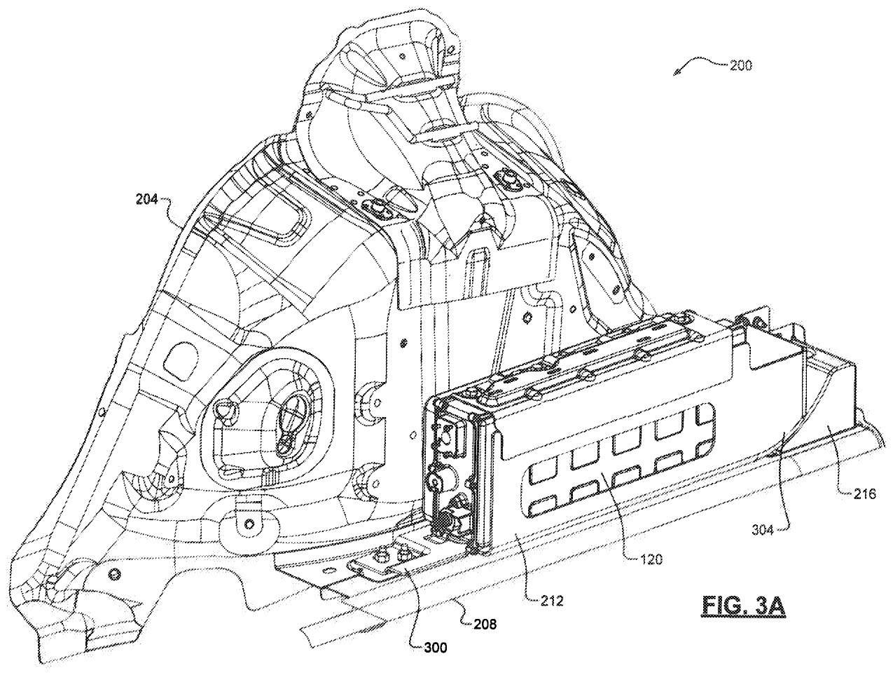

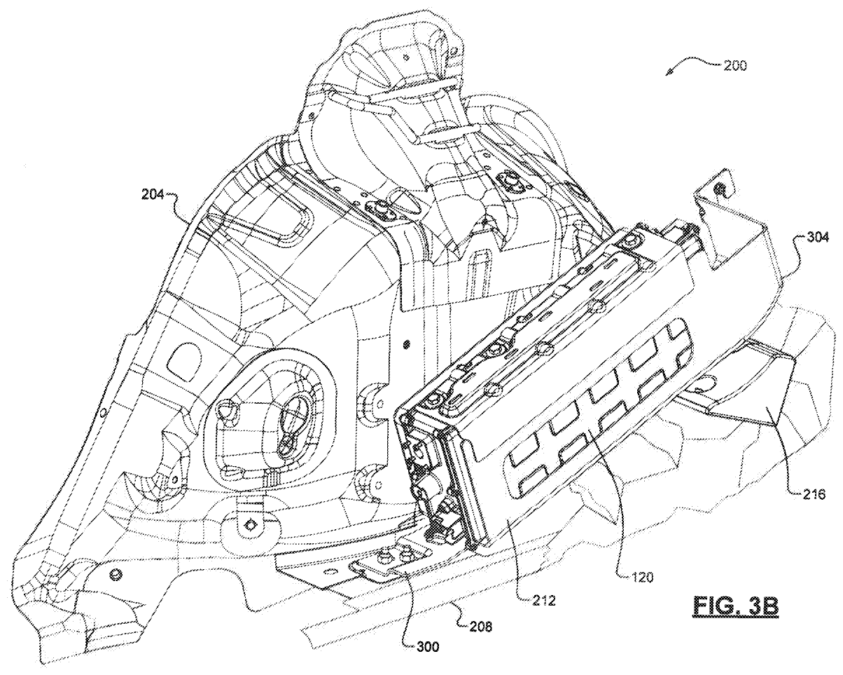

Referring now to FIGS. 3A-3B, side view diagrams of the protective system 200 for the high voltage module 120 before and during or after a vehicle rear impact event are illustrated. In FIG. 3A (before impact), a front end portion 300 of the housing 212 is securely connected to the vehicle frame floor portion 208. For example, this could be a bracket that extends in front of the high voltage module 120 and couples to the vehicle frame floor portion 208 via one or more screws, bolts, or similar attachment devices. A rear end portion 304 of the housing 212 is disconnected or loosely connected to the vehicle frame floor portion 208 for lateral constraint. The displacement device 216 is contacting or is in very close proximity to the rear end portion 304 of the housing 212. While a wedge device is shown for the displacement device 216, it will be appreciated that another suitable device could be utilized (e.g., a bracket configured to bend during impact and vertically displace the rear end portion 304 of the housing 212).

In FIG. 3B (during or after impact), a rearward portion of the vehicle frame floor portion 208 has buckled due to the rear impact event (e.g., from a collision by another vehicle), which causes the displacement device 216 to movably contact the rear end portion 304 of the housing 212, thereby vertically displacing at least the rear end portion 304 of the housing 212 and protecting the high voltage module 120 from damage. When the rear end portion 304 is loosely connected to the vehicle frame floor portion 208 before impact, this loose connection is broken in response to the rear impact event (i.e., the rear end portion 304 breaks free from the frame floor portion 208, the wedge-type displacement device 216 movably contacts the rear end portion 304 to vertically displace the rear end portion 304 and the high voltage module 120 therein to move the high voltage module out of the crush zone.

More specifically, in the crush zone, the frame is compressed forward to where the rear end portion 304 is loosely connected to the frame floor portion 208, thereby laterally pushing the wedge-type displacement device 216 in the same direction, which breaks the loose connection and lifts the rear end portion 304 and the high voltage module therein 120 upward and out of the crush zone so the high voltage module 120 is not crushed by the compressed frame. As shown, the front end portion 300 of the housing 212 remains securely connected to the vehicle frame floor portion 208. It will be appreciated that, in addition to protecting the high voltage module 120 and its associated lines 124, 144 from damage the associated cost savings, the protective system 200 could allow the vehicle 100 to continue operation after the rear impact event (e.g., to allow the driver to reach a service station). This could be applicable to, for example, minor rear impact events.

It should be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A protective system for a high voltage module of an electrified vehicle, the high voltage module being arranged at least partially in a crush zone of the vehicle, the protective system comprising:
a housing defining a front end and a rear end and having the high voltage module disposed therein, wherein the front end is securely connected to a frame of the vehicle and the rear end is disconnected from or loosely connected to the frame, the front end also including high voltage wiring for the high voltage module; and
a displacement device connected to the frame behind the rear end of the housing, wherein in response to a vehicle impact event that compresses the frame in the crush zone, the displacement device is configured to vertically displace the rear end of the housing and the high voltage module therein, thereby protecting the high voltage module and the high voltage wiring from damage during compression of the crush zone housing the high voltage module.

2. The protective system of claim 1, wherein the crush zone is beneath or behind rear seats of the vehicle and proximate to a rear wheel well portion and a floor portion of the frame of the vehicle.

3. The protective system of claim 2, wherein the vehicle impact event is a rear end impact.

4. The protective system of claim 3, wherein the rear end of the housing is loosely connected to the frame such that it is laterally constrained and, in response to the rear end impact, the rear end of the housing breaks free from the frame, and wherein the displacement device is a wedge device that movably contacts the rear end of the housing to vertically displace the rear end of the housing and the high voltage module therein to move the high voltage module out of the crush zone.

5. The protective system of claim 4, wherein, in the crush zone, the frame is compressed forward to where the rear end of the housing is loosely connected to the frame, thereby laterally pushing the wedge device in the same direction, which breaks the loose connection and lifts the rear end of the housing and the high voltage module therein upward and out of the crush zone so the high voltage module is not crushed by the compressed frame.

6. The protective system of claim 1, wherein the high voltage module is an integrated dual charging module (IDCM) comprising both a power inverter module (PIM) and a charging control module.

7. An electrified vehicle, comprising:
a frame defining a crush zone where, in response to a vehicle impact event, at least a portion of the frame defining the crush zone compresses;
a high voltage module arranged at least partially in the crush zone of the vehicle, the high voltage module being configured to output a high voltage and having high voltage wiring connected thereto; and
a protective system for the high voltage module, the protective system comprising:
a housing defining a front end and a rear end and having the high voltage module disposed therein, the front end being securely connected to the frame and the rear end being disconnected from or loosely connected to the frame, the front end including the high voltage wiring, and
a displacement device connected to the frame behind the rear end of the housing, wherein in response to the vehicle impact event, the displacement device movably contacts the rear end of the housing to vertically displace the rear end of the housing and the high voltage module therein, thereby protecting the high voltage module and the high voltage wiring from damage during compression of the crush zone housing the high voltage module.

8. The vehicle of claim 7, wherein the crush zone is beneath or behind rear seats of the vehicle and proximate to a rear wheel well portion and a floor portion of the frame of the vehicle.

9. The vehicle of claim 8, wherein the vehicle impact event is a rear end impact.

10. The vehicle of claim 9, wherein the rear end of the housing is loosely connected to the frame such that it is laterally constrained and, in response to the rear end impact, the rear end of the housing breaks free from the frame, and wherein the displacement device is a wedge device that movably contacts the rear end of the housing to vertically displace the rear end of the housing and the high voltage module therein to move the high voltage module out of the crush zone.

11. The protective system of claim 10, wherein, in the crush zone, the frame is compressed forward to where the rear end of the housing is loosely connected to the frame, thereby laterally pushing the wedge device in the same direction, which breaks the loose connection and lifts the rear end of the housing and the high voltage module therein upward and out of the crush zone so the high voltage module is not crushed by the compressed frame.

12. The vehicle of claim 7, wherein the high voltage module is an integrated dual charging module (IDCM) comprising both a power inverter module (PIM) and a charging control module.
